(19) United States
(12) Patent Application Publication
(10) Pub. No.: US 2026/0238759 A1
(43) Pub. Date: Aug. 13, 2026

(54) METHOD AND APPARATUS FOR WARP MODE SIGNALING

(71) Applicant: Tencent America LLC, Palo Alto, CA (US)

(72) Inventors: Jayasingam ADHURAN, Palo Alto, CA (US); Liang ZHAO, Palo Alto, CA (US); Madhu PERINGASSERY KRISHNAN, Palo Alto, CA (US); Shan LIU, Palo Alto, CA (US)

(21) Appl. No.: 19/372,078

(22) Filed: Oct. 28, 2025

Related U.S. Application Data
(60) Provisional application No. 63/756,740, filed on Feb. 10, 2025.

(51) Int. Cl. H04N 19/105; H04N 19/139; H04N 19/176; H04N 19/70

(52) U.S. Cl. CPC H04N 19/105; H04N 19/139; H04N 19/176; H04N 19/70

(57) ABSTRACT

An example method includes receiving a video bitstream comprising a plurality of blocks, including a current block. The method includes determining that the current block is coded in a warp mode of a set of warp modes by parsing a motion mode syntax, wherein parsing the motion mode syntax is prediction mode independent. The method also includes reconstructing the current block using the warp mode.

### RELATED APPLICATIONS

This application claims priority to U.S. Provisional Patent Application No. 63/756,740, entitled “Method and Apparatus for Warp Mode Signaling,” filed Feb. 10, 2025, which is hereby incorporated by reference in its entirety.

### TECHNICAL FIELD

The disclosed embodiments relate generally to video coding, including but not limited to systems and methods for warp mode signaling.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes methods, systems, and non-transitory computer-readable storage media for applying warp mode signaling during video (image) compression. A video codec includes a plurality of function modules for one or more of: intra/inter prediction, transform coding, quantization, entropy coding, and in-loop filtering. Warp mode video coding is a technique in video compression that uses advanced motion models to more accurately predict motion between frames. Unlike simpler methods that assume uniform, translational movement, warp modes use affine or homographic projections to handle complex motions like panning, zooming, rotation, and shearing. The existing signaling structure of warp modes comprises a complex mode dependent signaling. Some embodiments of the present disclosure redesign motion mode signaling by eliminating mode dependent signaling for specific warp modes. As an example, a video decoder may determine that a current block of a received video bitstream is coded in a warp mode of a set of warp modes by parsing a motion mode syntax, where the parsing is prediction mode independent. The decoder may reconstruct the current block using the warp mode. In some embodiments, the syntaxes related to each warp mode are grouped and signaled separately to unify the signaling process. As a result, the signaling process is simplified and coding efficiency is improved.

In accordance with some embodiments, a method of video decoding includes (i) receiving a video bitstream comprising a plurality of blocks, including a current block; (ii) determining that the current block is coded in a warp mode of a set of warp modes by parsing a motion mode syntax, where parsing the motion mode syntax is prediction mode independent; and (iii) reconstructing the current block using the warp mode.

In accordance with some embodiments, a method of video encoding includes (i) receiving video data comprising a plurality of blocks, including a current block; (ii) determining that the current block is to be coded in a warp mode of a set of warp modes; (iii) encoding the current block using the warp mode; and (iv) signaling a motion mode syntax in a video bitstream, where the motion mode syntax indicates the warp mode and is signaled independently of a prediction mode of the current block.

In accordance with some embodiments, a method of storing a video bitstream that is generated by a video encoding method. The video bitstream comprises (a) coded information for a plurality of blocks including a current block; and (b) a motion mode syntax indicating that the current block is encoded in a warp mode of a set of warp modes. The video encoding method comprises: (i) determining that the current block is to be encoded in a warp mode; (ii) encoding the current block using the warp mode; and (iii) signaling the motion mode syntax in the video bitstream, wherein the motion mode syntax is signaled independently of a prediction mode of the current block.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates example motions samples used for deriving model parameters of a block using local warped motion predictions in accordance with some embodiments.

FIG. 4B illustrates motion vectors in blocks using a warp extend mode in accordance with to some embodiments.

FIG. 5A illustrates an example video decoding process in accordance with some embodiments.

FIG. 5B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes methods and systems for applying warp mode signaling for video compression. The present disclosure redesigns motion mode signaling by eliminating mode dependent signaling for specific warp modes. As an example, a video decoder may determine that the current block is coded in a warp mode of a set of warp modes by parsing a motion mode syntax, wherein the parsing is prediction mode independent. The decoder may reconstruct the current block using the warp mode. As a result, the signaling process is simplified and coding efficiency is improved.

Redesign of warp mode signaling in video coding is disclosed herein. The techniques described herein eliminate mode-dependent signaling for specific warp modes and introduces a unified approach where syntaxes related to each warp mode are grouped and signaled separately. This redesign removes dependencies on prediction modes, such as NEWMV and NEARMV, and eliminates the WARPMV mode, thereby streamlining the signaling process. As a result, the signaling structure is simplified, reducing redundancy and complexity in the codec implementation. The benefits include improved coding efficiency, faster encoding and decoding processes, and enhanced compression performance, as the streamlined signaling enables more effective utilization of advanced motion models without the overhead of multiple prediction modes. These approaches also facilitate easier integration and maintenance of video codecs, contributing to overall system robustness and scalability.

### Example Systems and Devices

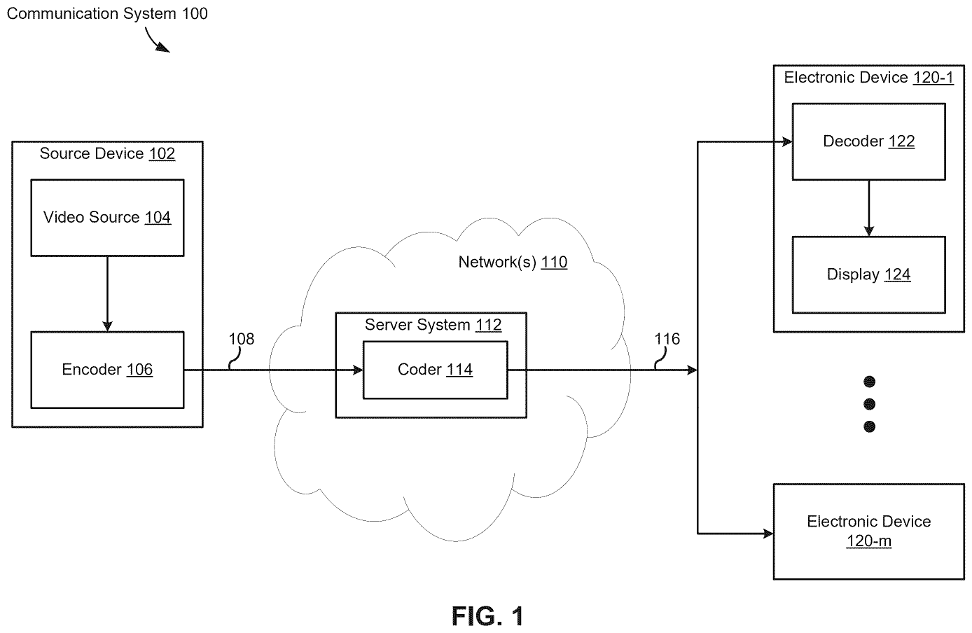

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

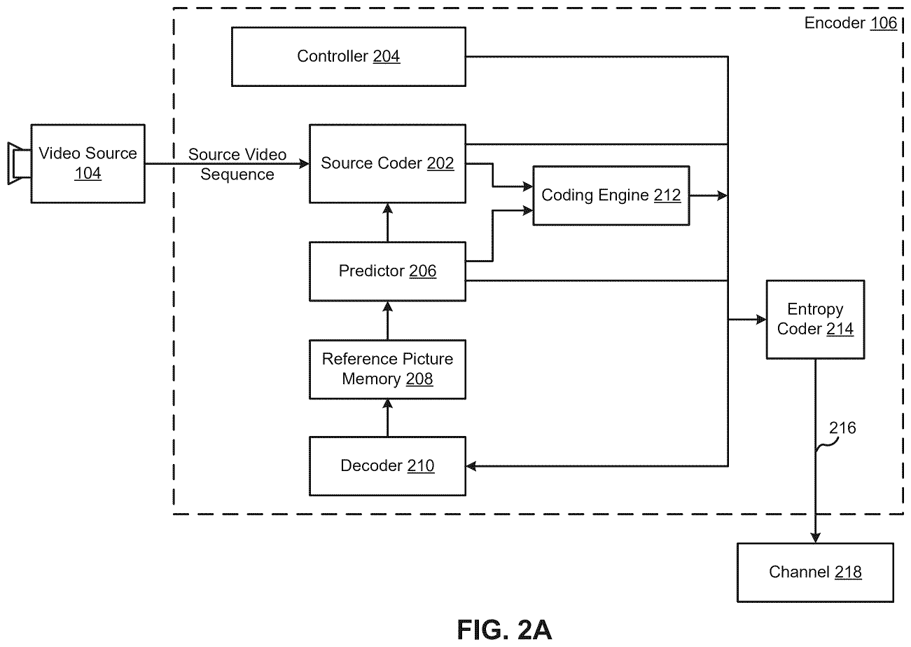

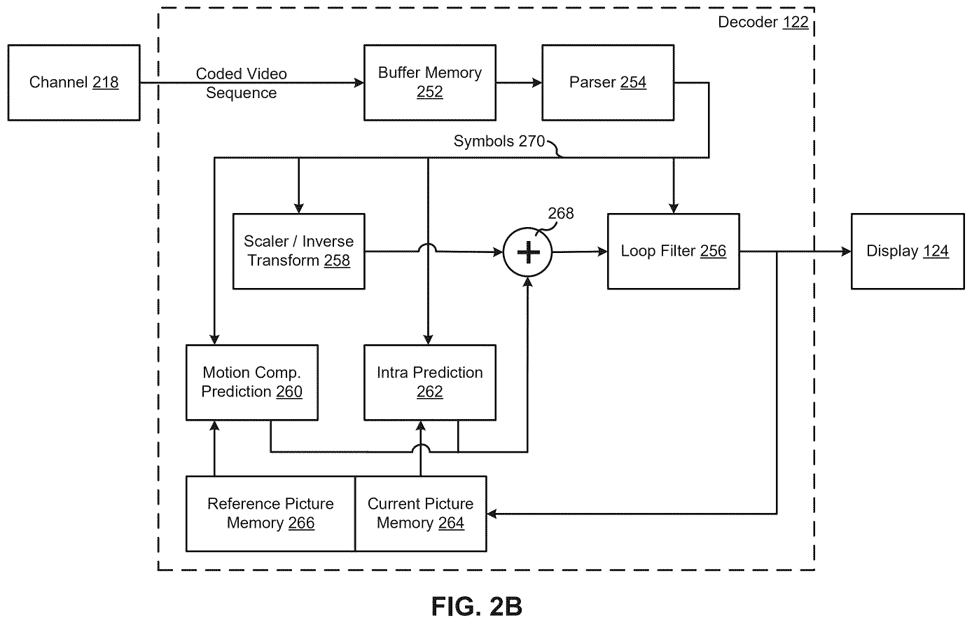

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

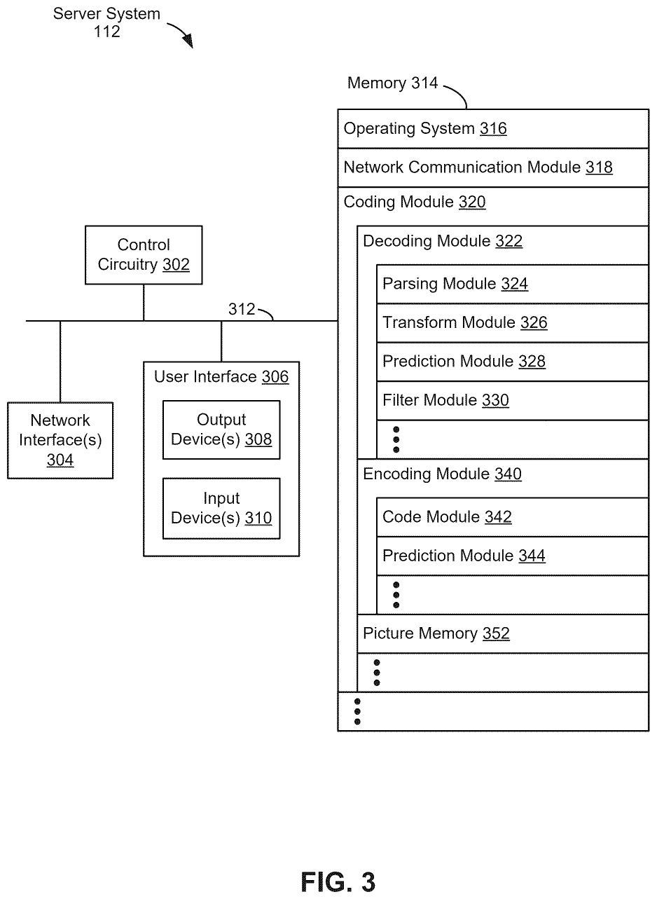

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for warp mode signaling are described.

Warp modes in video coding refer to advanced motion prediction techniques that enable more accurate modeling of complex motion between video frames. Unlike traditional translational motion models, which assume uniform movement across a block, warp modes utilize affine or homographic transformations to capture intricate motions such as rotation, scaling, shearing, and panning. By leveraging these sophisticated mathematical models, warp modes allow video codecs to efficiently predict and reconstruct blocks that exhibit non-linear or spatially varying motion, thereby improving compression efficiency and visual quality. The adoption of warp modes is particularly beneficial in scenarios where conventional motion compensation fails to represent the true motion characteristics of the video content, resulting in enhanced coding performance and reduced artifacts.

A set of inter coding tools can be applied to compress a video frame that includes temporal information (previous encoded frames), one of which is the Warp/Affine Motion Inter Prediction. Affine transformation is a linear transformation that preserves lines and parallelism. Affine transformations often include, and are not limited to, geometric transformations such as translation, rotate, scale, reflection and shear. This transformation can be attributed to computing motion differences. In this context an affine transformation can be represented as:

$$[ \begin{matrix}{x}^{′} \\ {y}^{′}\end{matrix} ] = [ \begin{matrix}a & b \\ c & d\end{matrix} ] [ \begin{matrix}x \\ y\end{matrix} ] + [ \begin{matrix}{t}_{x} \\ {t}_{y}\end{matrix} ] , \qquad ( Equation 1 )$$

where (x,y) is the original point, (x′,y′) is the transformed point,

$$[ \begin{matrix}a & b \\ c & d\end{matrix} ]$$

is a linear transformation matrix that determines rotation, scaling, reflection and shearing.

$$[ \begin{matrix}{t}_{x} \\ {t}_{y}\end{matrix} ]$$

represents translation motion, typically represented by the motion vectors.

As used herein, motion modes refer to the motion modes that are related to prediction using single reference frame. Table 1 shows a summary of motion modes in AVM.

TABLE 1
Summary of WARP motion modes in AVM

| Motion modes | Description |
|---|---|
| SIMPLE_TRANSLATION | Prediction samples for the current block is |
| | generated using motion vectors. |
| OBMC | Blending of prediction samples generated |
| | from the motion vector of the current |
| | block and the neighbouring blocks. |
| INTERINTRA | Blending of prediction samples generated |
| | from the motion vector of the current |
| | block and intra prediction modes. |
| WARP_EXTEND | Prediction samples for the current block is |
| | generated from the affine transformed |
| | reference block. Affine transformed |
| | reference block is obtained using motion |
| | vector of the current block and motion |
| | information from the neighbouring block. |
| WARPED_CAUSAL | Prediction samples for the current block is |
| | generated from the affine transformed |
| | reference block. Affine transformed |
| | reference block is obtained from a |
| | transformation model generated from |
| | projecting motion vectors from the |
| | neighbouring block. |
| WARP_DELTA | Prediction samples for the current block is |
| | generated from the affine transformed |
| | reference block. Affine transformed |
| | reference block is obtained from search |
| | for affine parameters. |

As used herein, warp mode refers to motion modes WARP_EXTEND, WARPED CAUSAL and WARP DELTA.

As used herein, the term modes refer to single prediction modes, including and not not limited to the motion vector driven inter prediction modes such as NEWMV, NEARMV, GLOBALMV, AMVDNEWMV, WARPMV. WARPMV mode is specifically related to motion modes WARPED CAUSAL and WARP DELTA.

Table 2 shows existing motion mode signaling and warp mode related syntax signaling in a video codec. In some embodiments, existing video codecs may not include syntaxes associated with OBMC. In some embodiments, the existing signaling structure of warp modes implies a complex mode dependent signaling. However, there is no distinctive cases for all warp modes, such as WARPMV mode excluding the WARP_EXTEND motion mode. Moreover, signaling of syntaxes relevant to warp modes are not streamlined to specific warp mode. Some embodiments of the present disclosure propose to streamline the signaling process of warp modes.

TABLE 2
Existing motion mode signaling and warp mode related syntax signaling

```
read_motion_mode( ){
  allowed_motion_modes = motion_mode_allowed( )
  if(mode == WAPMV){
    if (allowed_motion_modes & (1 <<
    WARPED_CAUSAL)){
```

| | |
|---|---|
| motion_mode | S( ) |

```
      if(motion_mode ==
      WARP_CAUSAL){
        return
      }
    }
    else{
      motion_mode = WARP_DELTA
    }
    return
  }
  if (allowed_motion_modes & (1 << INTERINTRA){
```

| | |
|---|---|
| motion_mode | S( ) |

```
    if (motion mode == INTERINTRA){
          read interintra( )
          return
    }
  }
  if (allowed_motion_modes & (1 << OBMC_CAUSAL) {
```

| | |
|---|---|
| motion_mode | S( ) |

```
    if (motion_mode == OBMC_CAUSAL){
          return
    }
  }
  if (allowed_motion_modes & (1 << WARP_EXTEND) {
```

| | |
|---|---|
| motion mode | S( ) |

```
    if (motion_mode == WARP_EXTEND){
          return
    }
  }
  if (allowed_motion_modes & (1 << WARPED_CAUSAL) {
```

| | |
|---|---|
| motion_mode | S( ) |

```
    if (motion_mode == WARPED_CAUSAL){
          return
    }
  }
  if (allowed_motion_modes & (1 << WARP_DELTA) {
```

| | |
|---|---|
| motion_mode | S( ) |

```
    if (motion_mode == WARP_DELTA){
          return
    }
  }
  motion_mode = SIMPLE_TRANSLATION
  return
}
read_inter_mode{
  is_warpmv_mode_allowed( ){
```

| | |
|---|---|
| use_warpmv | S( ) |

```
    if (use_warpmv == 1){
      mode = WARPMV
    }
  }
}
is_warpmv_warp_causal = (motion_mode == WARPED_CAUSAL) && mode ==
WARPMV
if(is_warpmv_warp_causal ∥motion_mode == WARP_DELTA ){
  find_warp_delta_base_candidates( )
```

| | |
|---|---|
| warp_ref_idx | S( ) |

```
  ref_warp_model(warp_ref_id
  x)
}
if(mode==WARP_MV && warp_ref_idx < 2) {
```

| | |
|---|---|
| warpmv_with_mvd_flag | S( ) |

}
if(mode==NEWMV ∥ mode==NEARMV){

| | |
|---|---|
| ref_mv_idx[0] | S( ) |

```
}
if (mode == WARPMV){
  ref_mv[0] = get_mv_from_wrl(warp_ref_idx)
}
else {
  ref_mv[0] = ref_mv_stack[ref_frame][ref_mv_idx[0]].mv
}
if (mode == WARPMV){
  if(warpmv_with_mvd_flag){
    read mvd(
    )
  }
}
if(mode==NEWMV){
  read_mvd( )
}
if(motion_mode==WARP_DELTA){
  if (mode != WARPMV && warp_ref_idx == 1){
    read_warp_delta( )
  }
}
```

In global warped motion compensation, global motion information is signaled for each inter reference frame, which includes a global motion type and several motion parameters. After signaling the reference frame index, if global motion is selected, the global motion type and the parameters associated with the given reference frame are used for the current coding block.

In local warped motion compensation, local warped motion may be allowed for an inter coding block when the following conditions are met. First, the current block must use a single reference prediction. The width or height of the coding block must be greater than or equal to eight. Finally, at least one of the adjacent neighboring blocks must use the same reference frame as the current block.

If local warped motion is used for the current block, the affine model parameters are estimated by mean-squared minimization of the difference between the reference and modeled projections based on the MVs of the current block and its adjacent neighboring blocks. To estimate the parameters of local warped motion, if the neighboring block uses the same reference frame as the current block, a projection sample pair of the center sample in the neighboring block and its corresponding sample in the reference frame are obtained. Subsequently, three extra samples are created by shifting the center position by a quarter sample in one or both dimensions. These extra samples may also be considered as projection sample pairs to ensure the stability of a model parameter estimation process.

The MVs of neighboring blocks, which are used to derive the motion parameters, are referred to as motion samples. The motion samples are selected from neighboring blocks that use the same reference frame as the current block. Note that the warped motion prediction mode is only enabled for blocks that use a single reference frame.

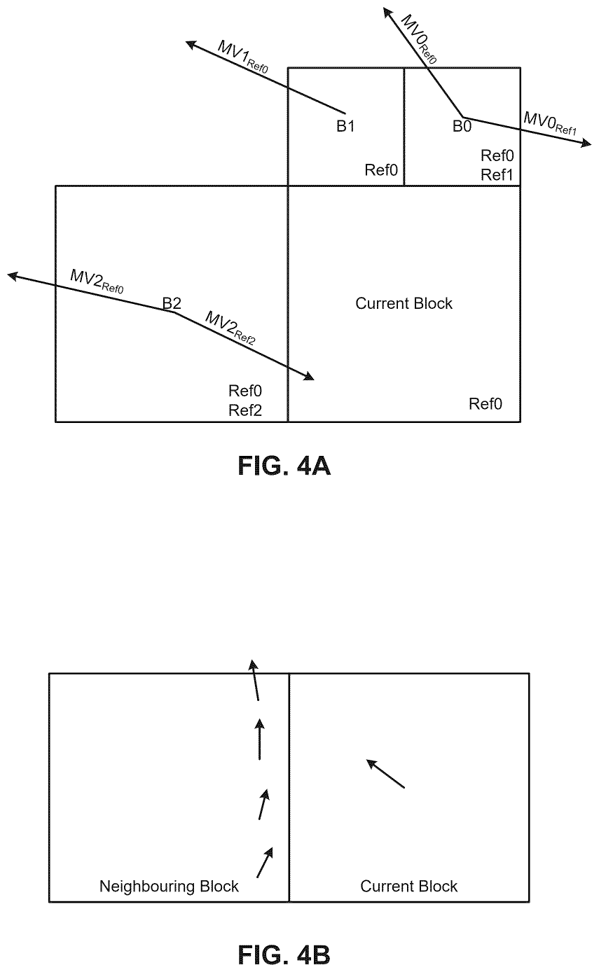

FIG. 4A illustrates example motions samples used for deriving model parameters of a block using local warped motion predictions in accordance with some embodiments. As shown in FIG. 4A, the MVs of neighboring blocks B0, B1, and B2 are referred as MV0, MV1, and MV2, respectively. The current block is predicted using uni-prediction with reference frame Ref0. For example, the neighboring block B0 is predicted using compound prediction with reference frames Ref0 and Ref1; the neighboring block B1 is predicted using uni-prediction with reference frame Ref0; and the neighboring block B2 is predicted using compound prediction with reference frames Ref0 and Ref2. The motion vector MV0_{Ref0} of B0, MV1_{Ref0} of B1 and MV2_{Ref0} of B2 may be used as the motion samples for deriving the affine motion parameters of the current block.

As mentioned above, two types of warped motion models may be supported: a global warp model and a local warp model. For example, the global warp model is associated with each reference frame, where each of the four non-translational parameters has 12-bit precision and the translational motion vector is coded in 15-bit precision. A coding block may choose to use it directly (provided the reference frame index). The global warp model captures the frame level scaling and rotation. As such, the global warp model primarily focuses on rigid motion over the entire frame. The local warp model at coding block level is also supported. In a local warp mode, also known as WARPED_CAUSAL, the warp parameters of the current block are derived by fitting a model to nearby motion vectors using least-squares.

In a warped motion mode, WARP_EXTEND, the motion of a neighboring block is smoothly extended into the current block, but with some ability to modify the warp parameters. This allows complex warping motions to be represented, spread across multiple blocks, while minimizing blocking artifacts. To accomplish this, the WARP_EXTEND mode, applied to NEWMV block, builds a new warp model based on two constraints: the per-pixel motion vectors generated by the new warp model should be continuous with the per-pixel motion vectors in a neighboring block, and the pixel at the center of the current block should have a per-pixel motion vector which matches the signalled motion vector for the block as a whole. FIG. 4B illustrates motion vectors in blocks using a warp extend mode in accordance with to some embodiments. As shown in FIG. 4B, for example, if the neighboring block at the left of the current block is warped, then a model which fits the motion vectors illustrated in FIG. 4B is used as the warp model.

The two constraints for building the new warp model imply certain equations involving the warp parameters of the neighboring block and the current block. These equations may then be solved to calculate the warp model for the current block. For example, if (A, . . . , F) represents the neighbor's warp model and (A′, . . . , F′) represents the new warp model, then the first constraint is as follows, at each point along the common edge:

$$\begin{matrix}First Constraint for Warp Modeling & \\ ( \begin{matrix}{A}^{′} & {B}^{′} \\ {C}^{′} & {D}^{′}\end{matrix} ) ( \begin{matrix}x \\ y\end{matrix} ) + ( \begin{matrix}{E}^{′} \\ {F}^{′}\end{matrix} ) = ( \begin{matrix}A & B \\ C & D\end{matrix} ) ( \begin{matrix}x \\ y\end{matrix} ) + ( \begin{matrix}E \\ F\end{matrix} ) & Equation 2\end{matrix}$$

Note that the points along the edge have different values of y, but they all have the same value of x. This means that the coefficients of y must be the same on both sides (e.g., B′=B and D′=D). Meanwhile, the x coefficients provide equations relating the other coefficients, defined by Equation 3 below:

$$\begin{matrix}x Coefficients Warp Modeling & \\ {B}^{′} = B & Equation 3\end{matrix}$$

$${D}^{′} = D$$

$${A}^{′} x + {E}^{′} = Ax + E$$

$${C}^{′} x + {F}^{′} = Cx + F$$

where, in Equation 3, x is the horizontal position of the vertical column of pixels, so is effectively a constant. The second constraint specifies that the motion vector at the center of the block must equal the one signaled using the NEWMV mechanism. This provides two further equations, resulting in a system of six equations in six variables which has a unique solution. These equations may be solved efficiently, both in software and in hardware. The solution may be solved using basic addition, subtraction, multiplication, and divisions by powers of 2. As such, this mode is significantly less complex than the least-squares based local warp mode.

There may be multiple neighboring blocks to extend from. Therefore, there needs to be a way to choose which block to extend from. This problem is similarly encountered in motion vector prediction. Specifically, there may be several possible motion vectors from nearby blocks, and the one should be selected as the base for NEWMV coding. The solution for this may be extended to handle the needs of WARP EXTEND. This is done by tracking the source of each motion vector prediction. Then, WARP_EXTEND is only enabled if the selected motion vector prediction is taken from a directly neighboring block. Then, that block is used as the single “neighboring block” in the rest of the algorithm.

Sometimes the neighbor's warp model will be very good as-is, without needing any further modification. To make this case cheaper to code, WARP_EXTEND may be used for NEARMV blocks. The neighbor selection is the same as for NEWMV, except that the selection in NEWMV requires the neighbor be warped (not just translated via the translational motion). But if this is true, and WARP_EXTEND is selected, then the neighbor's warp model parameters are copied to the current block.

In some embodiments, a motion mode, WARP_DELTA, may be used. In this mode, the block's warp model is coded as a delta from a predicted warp model, similar to how motion vectors are coded as a delta from a predicted motion vector. The prediction may be sourced from either the global motion model (if any), or a neighboring block.

To avoid having multiple ways to encode the same predicted warp model, restrictions may be applied. For example, if the mode is NEARMV or NEWMV, then the same neighbor selection logic as described for WARP EXTEND is used. If this results in a neighboring block which is warped, then that neighboring block's model (without applying the rest of the WARP_EXTEND logic) is used as the prediction. Otherwise, the global warp model is used as a base. Other restrictions may be applied. This example is not intended to limit the scope of embodiments. Then, a delta for each of the non-translational parameters may be coded. Finally, the translational part of the model is adjusted so that the per-pixel motion vector at the center of the block matches the block's overall motion vector.

As this tool (WARP_DELTA) involves explicitly coding a delta per warp parameter, it uses more bits to encode than the other warp modes. As such, WARP_DELTA may be disabled for blocks smaller than 16×16. However, the decode logic is extremely simple, and as such may represent more complex motion that the other warp modes cannot.

In an example single prediction mode (e.g., a WARPMV mode), the MV is derived from the warp model of the WRL list. The precision of the derived MV is set to ⅛th pel accuracy. In WARPMV mode, the dynamic reference list (DRL) is not used, therefore, the ref_mv_idx is not signaled.

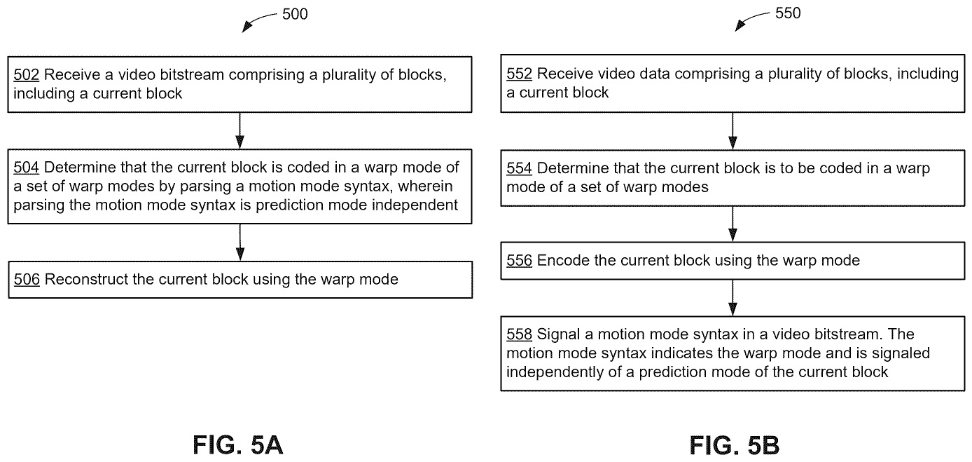

FIG. 5A is a flow diagram illustrating a method 500 of decoding video in accordance with some embodiments. The method 500 may be performed at a computing system (e.g., the server system 112, the source device 102, or the electronic device 120) having control circuitry and memory storing instructions for execution by the control circuitry. In some embodiments, the method 500 is performed by executing instructions stored in the memory (e.g., the memory 314) of the computing system.

The system receives (502) a video bitstream comprising a plurality of blocks, including a current block. The system determines (504) that the current block is coded in a warp mode of a set of warp modes by parsing a motion mode syntax, where parsing the motion mode syntax is prediction mode independent. The system reconstructs (506) the current block using the warp mode. In this way, warp mode signaling is redesigned to be prediction mode independent.

In some embodiments, motion mode signaling is redesigned by eliminating mode dependent signaling for specific warp modes. Secondly, the syntaxes related to each warp mode are grouped and signaled separately to unify the signaling process. In this disclosure, new syntaxes are introduced and WARPMV mode is eliminated. In some embodiments, motion mode signaling may not depend on prediction modes. In one example, the signaling of WARP DELTA and WARP_CAUSAL can be independent of WARPMV mode. In one example, redesigned motion mode signaling can be as shown in Table 3.

TABLE 3
Example motion mode signaling

| read_motion_mode( ){ | |
|---|---|
| allowed_motion_modes = motion_mode_allowed( ) | |
| if (allowed_motion_modes & (1 << INTERINTRA){ | |
| motion_mode | S( ) |
| if (motion_mode == INTERINTRA){ | |
| read interintra( ) | |
| return | |
| } | |
| } | |
| if (allowed_motion_modes & (1 << OBMC_CAUSAL) { | |
| motion_mode | S( ) |
| if (motion_mode == OBMC_CAUSAL){ | |
| return | |
| } | |
| } | |
| if (allowed_motion_modes & (1 << WARP_EXTEND) { | |
| motion_mode | S( ) |
| if (motion_mode == WARP_EXTEND){ | |
| return | |
| } | |
| } | |
| if (allowed_motion_modes & (1 << WARPED_CAUSAL) { | |
| motion_mode | S( ) |
| if (motion_mode == WARPED_CAUSAL){ | |
| return | |
| } | |
| } | |
| if (allowed_motion_modes & (1 << WARP_DELTA) { | |
| motion_mode | S( ) |

```
    if (motion_mode == WARP_DELTA){
      return
    }
  }
  motion_mode = SIMPLE_TRANSLATION
  return
}
```

In some embodiments, each warp mode specific syntax are explicitly signaled for that particular warp mode. In one example, use_wrl_index_only flag is signaled when the motion mode is WARP_DELTA. In another example, has_wrl_index flag is signaled when the motion mode is WARP CAUSAL. In some embodiments, syntaxes related to WARPED CAUSAL motion mode are signaled. In some embodiments, DRL index signaling depends on the warp mode. In some embodiments, signaling of DRL index depends on the has_wrl_index flag and prediction modes. In one example, when the warp mode is WARPED CAUSAL, DRL may be signaled if the has_wrl_index flag is zero and prediction modes is NEWMV. In some embodiments, for WARPED_CAUSAL motion mode, whether it uses WRL list or not is explicitly signaled. In one example, has_wrl_index flag is signaled to indicate whether WRL list is used or not.

In some embodiments, motion vector predictors in WARPED_CAUSAL motion mode are determined from the WRL list only. In some embodiments, the index of WRL list determines if WARPED CAUSAL would have motion vector difference signaling or not. In one example, when the index of WRL list less than a threshold T, motion vector differences are signaled. In one example T is set to 2. In some embodiments, WARPED CAUSAL motion mode employs WRL based MV prediction method only. In some embodiments, signaling of syntax related to WARPED_CAUSAL is shown in Table 4.

TABLE 4
Syntax table for WARPED_CAUSAL motion mode

| if (motion_mode == WARPED_CAUSAL){ | |
|---|---|
| has_wrl_index | S( ) |
| if (has_wrl index == 1) { | |
| find_warp_delta_base_candidates( ) | |
| warp_ref_idx | S( ) |
| ref_warp_model(warp_ref_idx) | |
| if(warp_ref_idx <2){ | |
| warpmv_with_mvd_flag | S( ) |
| } | |
| ref_mv[0] = | |
| get_mv_from_wrl(warp_ref_idx) | |
| if(warpmv_with_mvd_flag){ | |
| read_mvd( ) | |
| } | |
| } | |
| else{ | |
| if(mode==NEWMV ∥ mode==NEARMV){ | |
| ref_mv_idx[0] | S( ) |

```
    }
    if(mode==NEWMV){
      read_mvd( )
    }
  }
}
```

In some embodiments, syntaxes related to WARP_DELTA motion mode are signaled. In some embodiments, DRL index signaling may depend on the warp mode. In some embodiments, signaling of DRL index may depend on the use_wrl_index_only flag and prediction modes. In one example, when the warp mode is WARPED_DELTA, DRL may be signaled if the use_wrl_index_only flag is zero and prediction modes is NEWMV.

In some embodiments, WARP_DELTA motion mode have a specific syntax to signal if it only uses WRL list or not. For example, use_wrl_index_only flag is signaled to indicate whether only WRL list is used or not. In some embodiments, all of the warp parameters in WARP DELTA motion mode are determined from WRL list only. In some embodiments, index of WRL list may determine the number if WARP DELTA would have motion vector difference signaling. For example, when the index of WRL list is less than a threshold T, motion vector differences are signaled. For example, T is set to 2. In some embodiments, translational parameter in WARP_DELTA motion is determined using DRL list. For example, signaling of syntax related to WARP_DELTA can be as shown in Table 5.

TABLE 5
Syntax table for WARP_DELTA motion mode

| | |
|---|---|
| if (motion_mode == WARP_DELTA){ | |
| use_wrl_index_only | S( ) |
| find_warp_delta_base_candidates( ) | |
| warp_ref_idx | S( ) |
| ref_warp_model(warp_ref_idx) | |
| if (use_wrl_index_only == 1){ | |
| if(warp_ref_idx < 2){ | |
| warpmv_with_mvd_flag | S( ) |
| } | |
| ref_mv[0] = get_mv_from_wrl(warp_ref_idx) | |
| if(warpmv_with_mvd_flag){ | |
| read_mvd( ) | |
| } | |
| } | |
| else{ | |
| if(mode==NEWMV ∥ mode==NEARMV){ | |
| ref_mv_idx[0] | S( ) |
| } | |
| if(mode==NEWMV){ | |
| read_mvd( ) | |
| } | |
| if ( warp_ref_idx == 1){ | |
| read_warp_delta( ) | |
| } | |
| } | |
| } | |

In some embodiments, syntaxes related to WARP_EXTEND motion mode are signaled. In some embodiments, DRL index signaling may depend on the warp mode and the prediction mode. In one example, when the warp mode is WARPED_EXTEND, DRL may be signaled if the prediction modes is NEWMV. In one example, signaling of syntax related to WARP EXTEND can be as shown in Table 6.

TABLE 6
Syntax table for WARP_EXTEND motion mode

| if (motion_mode == WARP_EXTEND){ | |
|---|---|
| if(mode==NEWMV ∥ mode==NEARMV){ | |
| ref_mv_idx[0] | S( ) |

```
  }
  if(mode==NEWMV){
    read_mvd( )
  }
}
```

Some embodiments redesign the warp motion mode signaling by separately signaling warp modes and non-warp modes. Additionally, the syntaxes related to each warp mode are grouped and signaled separately to simplify the signaling process. In some embodiments, warp modes and non-warp modes are signaled separately. In some embodiments, whether a motion mode is warp or not is explicitly signaled.

In some embodiments, all warp modes are signaled one after the other and the process is terminated when the right mode is obtained. In one example, if a block applies warp mode, first is_warp_mode flag is signaled. To indicate if the mode is warp or not. If warp mode, then whether the motion mode is WARP_CAUSAL or not is signaled. In some embodiments, signaling of WARP_EXTEND and WARP DELTA depends on whether the block uses WRL list or not. In one example, a has_wrl_index is signaled to indicate whether the motion mode is WARP EXTEND or not. In one example, if the has_wrl_index flag is zero, motion mode is set to WARP_EXTEND. In one example, modified motion mode signaling can be as shown in Table 7.

TABLE 7
Redesigned motion mode signaling

| read_motion_mode( ){ | |
|---|---|
| allowed_motion_modes = motion_mode_allowed( ) | |
| is_warp_mode | S( ) |
| if(is_warp_mode == 0){ | |
| if (allowed_motion_modes & (1 << | |
| INTERINTRA){ | |
| motion_mode | S( ) |
| if (motion_mode == | |
| INTERINTRA){ | |
| return | |
| } | |
| if (allowed_motion_modes & (1 << | |
| OBMC_CAUSAL) { | |
| motion_mode | S( ) |
| if (motion_mode == | |
| OBMC_CAUSAL){ | |
| return | |
| } | |
| } | |
| motion_mode = SIMPLE_TRANSLATION | |
| return | |
| } | |
| if (allowed_motion_modes & (1 << WARPED_CAUSAL) { | |
| motion_mode | S( ) |
| if (motion_mode == | |
| WARPED_CAUSAL){ | |
| return | |
| } | |
| } | |
| has_wrl_index | S( ) |

```
  if(has_wrl_index == 0)
    motion_mode = WARP_EXTEND
    return
  }
  motion_mode = WARP_DELTA
  return
}
```

In some embodiments, each warp mode specific syntax is explicitly signaled for that particular warp mode. In one example, use_wrl_index_only flag is signaled when the motion mode is WARP DELTA.

In some embodiments, syntaxes related to WARPED_CAUSAL motion mode is signaled. In some embodiments, WARPED_CAUSAL motion mode whether it uses WRL list or not is explicitly signaled. In one example, signaling of syntax related to WARPED CAUSAL can be as shown in Table 8. In some embodiments, syntaxes related to WARP DELTA and WARP EXTEND motion modes are signaled separately.

TABLE 8
Syntax table for WARPED_CAUSAL motion mode

| if (motion_mode == WARPED_CAUSAL){ | |
|---|---|
| if (has_wrl_index== ){ | |
| find_warp_delta_base_candidates( ) | |
| warp_ref_idx | S( ) |
| ref_warp_model(warp_ref_idx) | |
| if(warp_ref_idx < 2){ | |
| warpmv_with_mvd_flag | S( ) |
| } | |
| ref_mv[0] = get_mv_from_wrl(warp_ref_idx) | |
| if(warpmv_with_mvd_flag){ | |
| read_mvd( ) | |
| } | |
| } | |
| else{ | |
| if(mode==NEWMV ∥ mode==NEARMV){ | |
| ref_mv_idx[0] | S( ) |

```
    }
    if(mode==NEWMV){
      read_mvd( )
    }
  }
}
```

Some embodiments propose to redesign the warp motion mode signaling by separately signaling warp modes and non-warp modes. Additionally, a prediction mode that is specific to all warp modes is introduced. This removes the dependency from other prediction modes such as NEWMV and NEARMV when warp modes are used. Additionally, the syntaxes related to each warp mode are grouped and signaled separately to simplify. In some embodiments, warp modes and non-warp modes is signaled separately.

In some embodiments, whether a motion mode is warp or not is explicitly signaled. In some embodiments, signaling warp modes depends on prediction mode. In one example, warp modes are signaled when the prediction mode is WARPMV.

In some embodiments, a prediction mode WARPMV represents all motion modes. In some embodiments, prediction modes other than WARPMV are not associated with warp modes. In one example, encoding, decoding and rate-distortion optimization process of warp modes are performed when the prediction mode is WARPMV.

In some embodiments, all warp modes can be signaled one after the other and the process is terminated when the right mode is obtained. In one example, if a block applies WARPMV mode, firstly whether used motion mode is WARP_EXTEND or not is signaled. Then, whether used motion mode is WARP_CAUSAL or not is signaled. In one example, modified motion mode signaling can be as shown in Table 9.

TABLE 9
Redesigned motion mode signaling

| read_motion_mode( ){ | |
|---|---|
| allowed_motion_modes = motion_mode_allowed( ) | |
| if(mode != WARPMV){ | |
| if (allowed_motion_modes & (1 << | |
| INTERINTRA){ | |
| motion_mode | S( ) |
| if (motion_mode == | |
| INTERINTRA){ | |
| return | |
| } | |
| } | |
| if (allowed_motion_modes & (1 << | |
| OBMC_CAUSAL) { | |
| motion_mode | S( ) |
| if (motion_mode == | |
| OBMC_CAUSAL){ | |
| return | |
| } | |
| } | |
| motion_mode = SIMPLE_TRANSLATION | |
| return | |
| } | |
| if (allowed_motion_modes & (1 << WARP_EXTEND) { | |
| motion_mode | S( ) |
| if (motion_mode == WARP_EXTEND){ | |
| return | |
| } | |
| } | |
| if (allowed_motion_modes & (1 << WARPED_CAUSAL) | |
| { | |
| motion_mode | S( ) |

```
    if (motion_mode == WARPED_CAUSAL){
        return
    }
  }
  motion_mode = WARP_DELTA
  return
}
```

In some embodiments, each warp mode related syntax is explicitly signaled for that particular warp mode. In one example, use_wrl_index_only flag is signaled when the motion mode is WARP DELTA. In another example, has_wrl_index flag is signaled when the motion mode is WARP_CAUSAL. In some embodiments, syntaxes related to WARPED CAUSAL motion mode may be signaled separately. In some embodiments, DRL index signaling depends on the warp mode. In some embodiments, signaling of DRL index depends on the has_wrl_index flag. In one example, when the warp mode is WARPED_CAUSAL, DRL may be signaled if the has_wrl_index flag is zero. In some embodiments, for WARPED CAUSAL motion mode, whether it uses WRL list or not is explicitly signaled. In one example, has_wrl_index flag is signaled to indicate whether WRL list is used or not. In some embodiments, motion vector predictors in WARPED_CAUSAL motion mode are determined from the WRL list only. In some embodiments, the index of WRL list may determine if WARPED CAUSAL would have motion vector difference signaling or not. In one example, when the index of WRL list less than a threshold T, motion vector differences are signaled. In one example T is set to 2. In some embodiments, WARPED_CAUSAL motion mode may employ DRL based MV prediction method only.

In some embodiments, signaling DRL index and motion vector difference depends on has_wrl_index flag. In one example, the DRL index and motion vector differences are signaled if the has_wrl_index flag is zero. In one example, signaling of syntax related to WARPED_CAUSAL can be as shown in Table 10.

TABLE 10
Syntax table for WARPED_CAUSAL motion mode

| | |
|---|---|
| if (motion_mode == WARPED_CAUSAL){ | |
| has_wrl_index | S( ) |
| if (has_wrl_index == 1){ | |
| find_warp_delta_base_candidates( ) | |
| warp_ref_idx | S( ) |
| ref_warp_model(warp_ref_idx) | |
| if(warp_ref_idx < 2){ | |
| warpmv_with_mvd_flag | S( ) |
| } | |
| ref_mv[0] = get_mv_from_wrl(warp_ref_idx) | |
| if(warpmv_with_mvd_flag){ | |
| read_mvd( ) | |
| } | |
| } | |
| else{ | |
| ref_mv_idx[0] | S( ) |
| read_mvd( ) | |
| } | |
| } | |

In some embodiments, syntaxes related to WARP_DELTA motion mode are signaled separately. In some embodiments, DRL index signaling depends on the warp mode. In some embodiments, signaling of DRL index depends on the use_wrl_index_only flag. In one example, when the warp mode is WARPED_DELTA, DRL may be signaled if the use_wrl_index_only flag is zero. In some embodiments, WARP_DELTA motion mode may have a specific syntax to signal if it only uses WRL list or not. In one example, use_wrl_index_only flag is signaled to indicate whether only WRL list is used or not. In some embodiments, all of the warp parameters in WARP_DELTA motion mode are determined from WRL list only. In some embodiments, the index of WRL list determines if WARP DELTA would have motion vector difference signaling. In one example, when the index of WRL list is less than a threshold T, motion vector differences are signaled. In one example T is set to 2.

In some embodiments, translational parameter in WARP_DELTA motion is determined using DRL list. In some embodiments, signaling DRL index and motion vector difference and may depend on use_wrl_index_only flag. For example, the DRL index and motion vector differences are signaled if the use_wrl_index_only flag is zero. In another example, signaling of syntax related to WARP_DELTA can be as shown in Table 11.

TABLE 11
Syntax table for WARP_DELTA motion mode

| | |
|---|---|
| if (motion_mode == WARP_DELTA){ | |
| use_wrl_index_only | S( ) |
| find_warp_delta_base_candidates( ) | |
| warp_ref_idx | S( ) |
| ref_warp_model(warp_ref_idx) | |
| if (use_wrl_index_only == 1){ | |
| if(warp_ref_idx < 2){ | |
| warpmv_with_mvd_flag | S( ) |
| } | |
| ref_mv[0] = get_mv_from_wrl(warp_ref_idx) | |
| if(warpmv_with_mvd_flag){ | |
| read_mvd( ) | |
| } | |
| } | |
| else{ | |
| ref_mv_idx[0] | S( ) |
| read_mvd( ) | |
| if ( warp_ref_idx == 1){ | |
| read_warp_delta( ) | |
| } | |
| } | |
| } | |

In some embodiments, syntaxes related to WARP_EXTEND motion mode are signaled separately. In some embodiments, DRL index signaling depends on the warp mode. For example, when the warp mode is WARPED_EXTEND, DRL may be signaled. For example, signaling of syntax related to WARP_EXTEND can be as shown in Table 12.

TABLE 12
Syntax table for WARP_EXTEND motion mode

| | |
|---|---|
| if (motion_mode == WARP_EXTEND){ | |
| ref_mv_idx[0] | S( ) |
| read_mvd( ) | |
| } | |

FIG. 5B is a flow diagram illustrating a method 550 of encoding video in accordance with some embodiments. The method 550 may be performed at a computing system (e.g., the server system 112, the source device 102, or the electronic device 120) having control circuitry and memory storing instructions for execution by the control circuitry. In some embodiments, the method 550 is performed by executing instructions stored in the memory (e.g., the memory 314) of the computing system. In some embodiments, the method 550 is performed by a same system as the method 600.

The system receives (552) video data comprising a plurality of blocks, including a current block. The system determines (554) that the current block is to be coded in a warp mode of a set of warp modes. The system encodes (556) the current block using the warp mode. The system signals (558) a motion mode syntax in a video bitstream. The motion mode syntax indicates the warp mode and is signaled independently of a prediction mode of the current block. As described previously, the encoding process may mirror the decoding processes described herein (e.g., warp mode signaling and parsing). For brevity, those details are not repeated here.

Although FIGS. 5A and 5B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.
(A1) In one aspect, some embodiments include a method (e.g., the method 500) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of blocks, including a current block; (ii) determining that the current block is coded in a warp mode of a set of warp modes by parsing a motion mode syntax, wherein parsing the motion mode syntax is prediction mode independent; and (iii) reconstructing the current block using the warp mode. In this way, motion mode signaling is redesigned by eliminating mode dependent signaling for specific warp modes. Additionally, the syntaxes related to each warp mode are grouped and signaled separately to unify the signaling process. In some embodiments, the warp motion mode is signaled separately from non-warp modes. In some embodiments, the syntaxes related to each warp mode are grouped and signaled separately to simplify the signaling process. In some embodiments, a prediction mode that is specific to all warp modes is signaled, parsed, and used. This removes the dependency from other prediction modes such as NEWMV and NEARMV when warp modes are used. For example, a prediction mode WARPMV can represent all motion modes.
(A2) In some embodiments of A1, the warp mode is determined without considering a warp motion vector mode. As an example, new syntaxes are introduced and WARPMV mode is eliminated. For example, motion mode signaling may not depend on prediction modes.
(A3) In some embodiments of A1 or A2, the set of warp modes comprises a warp delta mode, a warp casual mode, and a warp extend mode. For example, the signaling of WARP DELTA and WARP_CAUSAL can be independent of WARPMV mode (e.g., as illustrated in Table 3).
(A4) In some embodiments of any of A1-A3, the method further comprises, after determining that the current block is coded in the warp mode, parsing one or more mode-specific parameters from the video bitstream, wherein the current block is reconstructed using the warp mode and the one or more mode-specific parameters. For example, each warp mode specific syntax may be explicitly be signaled for that particular warp mode. As an example, use_wrl_index_only flag may be signaled when the motion mode is WARP DELTA. As another example, has_wrl_index flag may be signaled when the motion mode is WARP CAUSAL.
(A5) In some embodiments of A4, the warp mode is warp causal mode, and wherein the one or more mode-specific parameters comprise a warp-causal parameter. For example, syntaxes related to WARPED_CAUSAL motion mode may be signaled.
(A6) In some embodiments of any of A1-A5, determining that the current block is coded in the warp mode comprises determining whether the current block is coded in one of: a translation mode; an overlapped block motion compensation (OBMC) mode; an inter-intra mode; a warp extend mode; a warp causal mode; and a warp delta mode.
(A7) In some embodiments of any of A1-A6, the method further comprises determining a dynamic reference list (DRL) index based on the warp mode. For example, DRL index signaling may depend on the warp mode.
(A8) In some embodiments of A7, the DRL index is parsed based on the warp mode and a prediction mode of the current block. For example, signaling of DRL index may depend on the has_wrl_index flag and prediction modes. As an example, when the warp mode is WARPED_CAUSAL, DRL may be signaled if the has_wrl_index flag is zero and prediction modes is NEWMV. For example, DRL index signaling may depend on the warp mode and the prediction mode. As an example, when the warp mode is WARPED_EXTEND, DRL may be signaled if the prediction modes is NEWMV. Table 6 illustrates example syntax for the warp extend mode.
(A9) In some embodiments of A7 or A8, the method further comprises determining a translational parameter for the warp mode based on the DRL. For example, translational parameter in WARP_DELTA motion is determined using DRL list. Table 5 illustrates example syntax for the warp delta mode.
(A10) In some embodiments of any of A1-A9, the method further comprises parsing an indicator in the video bitstream, the indicator indicating whether the warp mode uses a warp reference list (WRL). For example, for WARPED_CAUSAL motion mode, whether it uses WRL list or not is explicitly signaled. As an example, has_wrl_index flag may be signaled to indicate whether WRL list is used or not. As another example, WARP_DELTA motion mode may have a specific syntax to signal if it only uses WRL list or not. For example, use_wrl_index_only flag is signaled to indicate whether only WRL list is used or not.
(A11) In some embodiments of A10, the warp mode is warp causal mode, warp delta mode, or warp extend mode. For example, syntaxes related to WARP DELTA motion mode may be signaled. As an example, DRL index signaling may depend on the warp mode. For example, signaling of DRL index may depend on the use_wrl_index_only flag and prediction modes. As an example, when the warp mode is WARPED_DELTA, DRL may be signaled if the use_wrl_index_only flag is zero and prediction modes is NEWMV. As an example, syntaxes related to WARP EXTEND motion mode may be signaled.
(A12) In some embodiments of A10 or A11, the method further comprises determining one or more motion vector predictors using the WRL. For example, motion vector predictors in WARPED_CAUSAL motion mode may be determined from the WRL list only. As an example, WARPED_CAUSAL motion mode may employ WRL based MV prediction method only. Table 4 illustrates example syntax for the warp causal mode. For example, all of the warp parameters in WARP_DELTA motion mode may be determined from WRL list only.
(B1) In another aspect, some embodiments include a method (e.g., the method 550) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of blocks, including a current block; (ii) determining that the current block is to be coded in a warp mode of a set of warp modes; (iii) encoding the current block using the warp mode; and (iv) signaling a motion mode syntax in a video bitstream, wherein the motion mode syntax indicates the warp mode and is signaled independently of a prediction mode of the current block. In some embodiments, the method further includes transmitting encoded information for the current block in the video bitstream.
(B2) In some embodiments of B1, the warp mode is determined without considering a warp motion vector mode.
(B3) In some embodiments of B1 or B2, the set of warp modes comprises a warp delta mode, a warp casual mode, and a warp extend mode.
(B4) In some embodiments of any of B1-B3, the method further comprises signaling one or more mode-specific parameters in the video bitstream, wherein the current block is encoded using the warp mode and the one or more mode-specific parameters
(B5) In some embodiments of any of B1-B4, the method further comprises signaling an indicator in the video bitstream, the indicator indicating whether the warp mode uses a warp reference list (WRL).

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A12 and B1-B5 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A12 and B1-B5 above). In some embodiments, a memory or non-transitory computer-readable storage medium stores a video bitstream including any of the features (e.g., syntax and encoded information) disclosed herein.

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of blocks, including a current block;
determining that the current block is coded in a warp mode of a set of warp modes by parsing a motion mode syntax, wherein parsing the motion mode syntax is prediction mode independent; and
reconstructing the current block using the warp mode.

2. The method of claim 1, wherein the warp mode is determined without considering a warp motion vector mode.

3. The method of claim 1, wherein the set of warp modes comprises a warp delta mode, a warp casual mode, and a warp extend mode.

4. The method of claim 1, further comprising, after determining that the current block is coded in the warp mode, parsing one or more mode-specific parameters from the video bitstream, wherein the current block is reconstructed using the warp mode and the one or more mode-specific parameters.

5. The method of claim 4, wherein the warp mode is warp causal mode, and wherein the one or more mode-specific parameters comprise a warp-causal parameter.

6. The method of claim 1, wherein determining that the current block is coded in the warp mode comprises determining whether the current block is coded in one of:
a translation mode;
an overlapped block motion compensation (OBMC) mode;
an inter-intra mode;
a warp extend mode;
a warp causal mode; and
a warp delta mode.

7. The method of claim 1, further comprising determining a dynamic reference list (DRL) index based on the warp mode.

8. The method of claim 7, wherein the DRL index is parsed based on the warp mode and a prediction mode of the current block.

9. The method of claim 7, further comprising determining a translational parameter for the warp mode based on the DRL.

10. The method of claim 1, further comprising parsing an indicator in the video bitstream, the indicator indicating whether the warp mode uses a warp reference list (WRL).

11. The method of claim 10, wherein the warp mode is warp causal mode, warp delta mode, or warp extend mode.

12. The method of claim 10, further comprises determining one or more motion vector predictors using the WRL.

13. The method of claim 12, further comprising determining whether a motion vector difference is signaled in the video bitstream based on an index of the WRL for the current block.

14. A method of video encoding performed at a computing system having memory and one or more processors, the method comprising:
receiving video data comprising a plurality of blocks, including a current block;
determining that the current block is to be coded in a warp mode of a set of warp modes;
encoding the current block using the warp mode; and
signaling a motion mode syntax in a video bitstream, wherein the motion mode syntax indicates the warp mode and is signaled independently of a prediction mode of the current block.

15. The method of claim 14, wherein the warp mode is determined without considering a warp motion vector mode.

16. The method of claim 14, wherein the set of warp modes comprises a warp delta mode, a warp casual mode, and a warp extend mode.

17. The method of claim 14, further comprising signaling one or more mode-specific parameters in the video bitstream, wherein the current block is encoded using the warp mode and the one or more mode-specific parameters.

18. The method of claim 14, further comprising signaling an indicator in the video bitstream, the indicator indicating whether the warp mode uses a warp reference list (WRL).

19. A non-transitory computer-readable storage medium storing a video bitstream that is generated by a video encoding method, the video bitstream comprising:
coded information for a plurality of blocks including a current block; and
a motion mode syntax indicating that the current block is encoded in a warp mode of a set of warp modes;
wherein the video encoding method comprises:
determining that the current block is to be encoded in a warp mode;
encoding the current block using the warp mode; and
signaling the motion mode syntax in the video bitstream, wherein the motion mode syntax is signaled independently of a prediction mode of the current block.

20. The non-transitory computer-readable storage medium of claim 19, wherein the warp mode is signaled without considering a warp motion vector mode.
